(19) United States
(12) Patent Application Publication
(10) Pub. No.: US 2025/0376078 A1
(43) Pub. Date: Dec. 11, 2025

(54) SYSTEMS AND METHODS OF ANTI-CIRCULATION COOLING CONTROL

(71) Applicant: Caterpillar Inc., Peoria, IL (US)

(72) Inventors: Zhijun Cai, Dunlap, IL (US); Scott Alan Tipton, Washington, IL (US); Andrew John Olson, Vail, AZ (US); Bradley Paul Wrage, Pekin, IL (US)

(73) Assignee: Caterpillar Inc., Peoria, IL (US)

(21) Appl. No.: 18/737,978

(22) Filed: Jun. 8, 2024

(51) Int. Cl. B60L 58/26

(52) U.S. Cl. CPC B60L 58/26; B60L 2200/40

(57) ABSTRACT

Provided herein are systems and methods for enhancing thermal management of a battery pack of a heavy vehicle. For example, the heavy vehicle may include a battery pack, a first thermal management system including a plurality of fans, a second thermal management system including a coolant circuit arranged to cool the battery pack, and one or more processors configured to detect a charge event of the battery pack and, responsive to detecting the charge event, modify a fan speed of at least one of the plurality of fans of the first thermal management system to prioritize cooling of the battery pack via the second thermal management system.

### TECHNICAL FIELD

The present implementations relate generally to thermal systems and more particularly to systems and methods of anti-circulation cooling control for vehicles such as heavy vehicles.

### BACKGROUND

The present disclosure relates generally to cooling and heating systems, and more particularly to anti-circulation cooling control for heavy vehicles. In some implementations, one or more thermal regulation systems of a vehicle may be configured to regulate a thermal condition of various components, such as a battery pack. In such implementations, operation of one thermal regulation system may impact an efficiency of another thermal regulation system.

For example, U.S. patent application Ser. No. 17/399,238 describes a cooling system including plural fans configured to provide airflow across a radiator and a fan controller in communication with the plural fans. The fan controller is configured to receive operating condition data associated with at least one of the radiator and an engine. The fan controller is configured to determine a total target heat rejection value based on the operating condition data; determine a plurality of target fan operation values for the plural fans, based on the total target heat rejection value and the operating condition data; and control operation of the plural fans at plural independent fan speeds based on the plural fan operation values.

### SUMMARY

A first aspect provided herein relates to a heavy vehicle. The heavy vehicle may include a battery pack, a first thermal management system including a plurality of fans, a second thermal management system including a coolant circuit arranged to cool the battery pack, and one or more processors configured to detect a charge event of the battery pack and, responsive to detecting the charge event, modify a fan speed of at least one of the plurality of fans of the first thermal management system to prioritize cooling of the battery pack via the second thermal management system.

A second aspect provided herein relates to a system. The system may include a battery pack, a first thermal management system including a plurality of fans, a second thermal management system including a coolant circuit arranged to cool the battery pack, and one or more processors configured to detect a charge event of the battery pack and, responsive to detecting the charge event, modify a fan speed of at least one of the plurality of fans of the first thermal management system to prioritize cooling of the battery pack via the second thermal management system.

A third aspect provided herein relates to a method. The method may include detecting, by one or more processors, a charge event of the battery pack and, responsive to detecting the charge event, modifying a fan speed of at least one fan of a plurality of fans of a first thermal management system to prioritize cooling of the battery pack via a second thermal management system.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 is a block diagram of a system for enhancing thermal management of a battery pack, in accordance with present implementations;

FIG. 2 is a flowchart of a process of enhancing thermal management of a battery pack using an estimated heat load, in accordance with present implementations;

FIG. 3 is a flowchart showing a method of enhancing thermal management of a battery pack using an estimated heat load, in accordance with present implementations;

FIG. 4 is a flowchart of a process of enhancing thermal management of a battery pack using an estimated heat load during a charge event, in accordance with present implementations;

FIG. 5 is a flowchart showing a method of enhancing thermal management of a battery pack using an estimated heat load during a charge event, in accordance with present implementations;

FIG. 6 is a flowchart of a process of enhancing thermal management of a battery pack based on a thermal condition of one or more battery cells, in accordance with present implementations;

FIG. 7 is a flowchart showing a method of enhancing thermal management of a battery pack based on a thermal condition of one or more battery cells, in accordance with present implementations;

FIG. 8 is a flowchart of a process of enhancing thermal management of a battery pack by modifying a secondary thermal management system of a vehicle, in accordance with present implementations;

FIG. 9 is a flowchart showing a method of enhancing thermal management of a battery pack by modifying a secondary thermal management system of a vehicle, in accordance with present implementations.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods described herein may be configured, designed, or otherwise arranged to enhance thermal management of a battery pack by modifying a secondary cooling system of a vehicle. For example, a system of the vehicle may include a vehicle component thermal management (e.g., coolant) system configured to cool a vehicle component, such as an inverter or other component. The vehicle component coolant system may include a plurality of fans configured to cool the vehicle component. The system may include a battery coolant system configured to cool a battery pack for the vehicle. The system may include one or more processors (e.g., a battery management system, a battery thermal management system, or in another control unit) configured to selectively modify a fan speed of at least some of the fans of the vehicle component coolant system to prioritize coolant of the battery pack via the battery coolant system. For example, the one or more processors may decrease fan speed of some of the fans of the vehicle component coolant system when the battery pack is charging and/or when a temperature of the battery pack reaches a threshold value.

The one or more processors may selectively decrease a fan speed of some of the fans of the vehicle component coolant system to reduce circulation of warm air through the system to enhance the cooling capability and efficiency of the battery coolant system. For example, in heavy vehicles, such as large mining trucks, the battery coolant system and/or the vehicle component coolant system may be disposed at or near a front of the vehicle. Therefore, when the battery coolant system is not operating, but the vehicle component coolant system is operating, the front of the vehicle may build up air pressure from the fans of the vehicle component coolant system and may cause the pressure to circulate near the battery pack. Accordingly, the system may detect this pressure build up and may cause the vehicle component coolant system to operate the fans at a minimum speed to prevent air circulation and make the battery cooling more efficient.

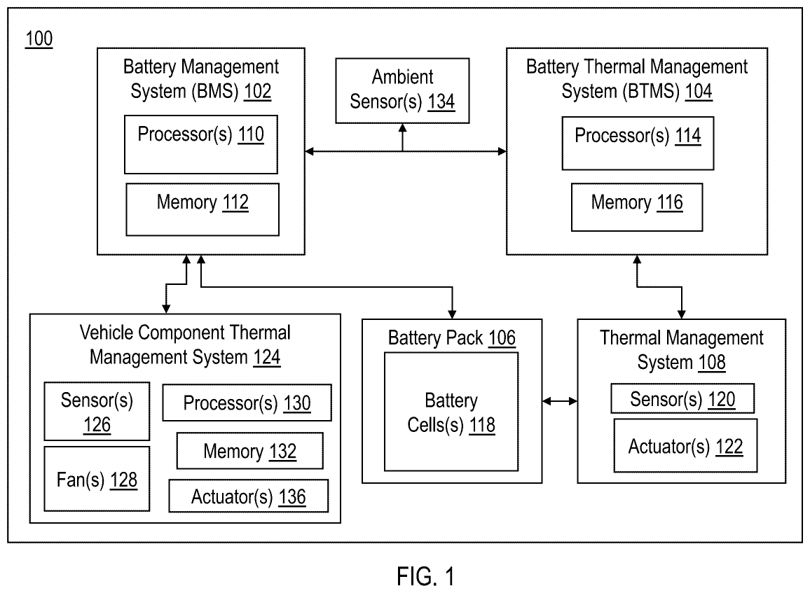

Referring now to FIG. 1, depicted is a block diagram of a system 100 for enhancing thermal management of a battery pack of a vehicle. For example, the system 100 may be coupled to or incorporated in various types of vehicles including, but not limited to, heavy vehicles (e.g., machinery or construction vehicles including, but not limited to, bulldozers, excavators, loaders, graders, forklifts, mining trucks, semi-trucks, dump trucks, concrete mixers, tanker trucks, flatbed trucks, heavy haulers, etc.), electric vehicles, aviation and/or marine vehicles, or various other locomotive. As described herein, the system 100 may include at least one battery pack to provide electric power to operate the vehicle. The system 100 may include various controllers to monitor and operate the battery pack and/or various other components of the system 100. For example, the system 100 may include one or more thermal management systems capable of thermally regulating the battery packs(s), including separate circuits with dedicated thermal management systems for pack(s) and/or other components of the system 100 to regulate a temperature of the battery pack as the battery pack provides electric power to the vehicle and/or as the battery pack is charged to store electric power for operating the vehicle.

The system 100 may include a battery management system (BMS) 102 configured to control and/or monitor a battery pack 106 of the system 100. The BMS 102 may include at least one processor 110 and memory 112. The processor(s) 110 may be or include any device, component, element, or hardware designed or configured to perform the various steps recited herein. For example, the processor(s) 110 may include any number of general purpose single- or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. In some embodiments, the BMS 102 may include a single processor 110 designed or configured to perform each of the various steps or acts recited herein. In some embodiments, the BMS 102 may include multiple processors 110 which are designed or configured perform (e.g., either separately or together) each of the various steps or acts recited herein. As one example, the BMS 102 may include a first processor 110 designed or configured to perform a first subset of the various steps or acts, and a second processor 110 designed or configured to perform a second subset of the various steps or acts (with the first subset being different from the second subset). As another example, the BMS 102 may include first and second processors 110 which together perform the various steps in a distributed fashion. As such, unless explicitly indicated otherwise, such as by use of a term such as “a single processor”, the term “one or more processor(s)” as used herein contemplates and encompasses embodiments in which all of the one or more processors perform all of the recited steps or features, different processors separately perform different ones of the steps or features, the same or different sets of two or more processors work in combination to perform individual steps or features, or any variation thereof. In other words, unless explicitly indicated otherwise, the use of the term “one or more processors” herein contemplates and encompasses a single processor performing all of the recites steps or features and two or more processors working individually or in combination, where each step or feature is performed by any one or combination of two or more of the processors. Moreover, the use of the term “one or more processors” may refer to the processor(s) 110 of the BMS 102 and/or the processors of other components of the system 100 described herein, such as the thermal management systems 104, 124. The memory 112 may be or include any type or form of data storage device, including tangible, non-transient volatile memory and/or non-volatile memory.

The BMS 102 may be communicably coupled to the battery pack 106 of the system 100. The BMS 102 may be structured or configured to monitor and/or manage various conditions of the battery pack 106 including, but not limited to, a voltage of individual battery cells 118 within the battery pack 106 and/or a voltage of the overall battery pack 106, a current flowing into or out of the battery pack 106, a temperature of the battery pack 106 and/or a temperature of the battery cells 118 (e.g., via one or more temperature sensors 120 disposed within the battery pack 106), a state of charge (SOC) of the battery pack 106 (e.g., a percentage charge, a percentage depletion, a remaining run time, and so forth), and/or a state of health (SOH) of the battery pack 106 (e.g., based on capacity and/or resistance as percentages of an initial capacity and resistance). The BMS 102 may be configured to additionally or alternatively monitor and/or manage a runtime, number of charge cycles, an internal resistance, a self-discharge rate, a cell temperature, a time history of various conditions, an impedance, and/or various other conditions of the battery pack 106. For example, the BMS 102, via the one or more processors 110, may be configured to receive information of the battery pack 106 from one or more sensors (e.g., voltage sensors, current sensors, temperature sensors, etc.) and/or from one or more monitoring circuits communicably coupled to the battery pack 106 and communicably coupled to the BMS 102. The BMS 102 may additionally be communicably coupled to one or more controllers within or external to the system 100 including, for example, a vehicle control unit (VCU), or another control unit (e.g., an external off-machine communication from a dispatch system), to receive and/or provide information about the battery pack 106 to another portion of the system 100 or vehicle.

The BMS 102 may be communicably coupled to a thermal management system, such as a battery thermal management system (BTMS) 104. While referred to herein as the “battery thermal management system,” the thermal management system 104 may be configured to regulate a temperature of various additional components of the vehicle. The BTMS 104 may include at least one processor 114 and memory 116. The processor(s) 114 and memory 116 may be similar or identical in configuration to the processor(s) 110 and memory 112 of the BMS 102 described above. The BMS 102 may be structured or configured to communicate with the BTMS 104 for controlling and/or monitoring a thermal condition (e.g., temperature) of one or more of the battery cells 118 within the battery pack 106. For example, the BTMS 104 may be communicably coupled to a thermal management system 108 for the battery pack 106 that is configured to cool or heat one or more portions of the battery pack 106. In some implementations, the thermal management system 108 may be at least partially disposed within and/or coupled to the battery pack 106 or the thermal management system 108 may be at least partially disposed or completely disposed external to the battery pack 106. For example, the thermal management system 108 may include one or more air cooling/heating systems having one or more fans, air ducts, or heat sinks, or the thermal management system 108 may include one or more liquid cooling/heating systems having pipes or channels for circulating a coolant through the battery pack 106. The thermal management system 108 may additionally or alternatively be configured to heat the battery cells 118 of the battery pack 106 via one or more air heating systems or liquid heating systems.

The thermal management system 108 may include or may be communicably coupled to one or more sensors 120 (e.g., temperature sensors) disposed throughout the battery pack 106 to monitor a temperature of one or more individual battery cells 118 and/or the battery pack 106 as a whole. For example, the battery pack 106 or the thermal management system 108 may include at least one sensor 120 configured to monitor a temperature of an individual battery cell 118 and/or the battery pack 106 or the thermal management system 108 may include at least one sensor 120 configured to monitor a temperature of a plurality of battery cells 118. In other words, the battery pack 106 may include sensors 120 for each of the plurality of battery cells 118 within the battery pack 106 such that each sensor 120 is configured to measure the temperature of an individual battery cell 118, or the battery pack 106 may include one or more sensors 120 configured to measure a temperature of a subset of the battery cells 118 (e.g., one cell 118, two cells, 118, etc.). Through the sensors 120, the BTMS 104 may be configured to receive or determine a maximum temperature of the battery cells 118, a minimum temperature of the battery cells 118, and/or an average temperature of a subset of the battery cells 118 or of all of the battery cells 118. The one or more sensors 120 may be additionally or alternatively configured to monitor a temperature of a component of the thermal management system 108 including, but not limited to, a temperature of a coolant or other fluid flowing through the thermal management system 108.

In some implementations, the BTMS 104 may be configured or structured as a controller for the thermal management system 108. For example, the BTMS 104 may be configured to receive data from the various sensors 120 of the thermal management system 108 and cause the thermal management system 108 to start, stop, or modify a component of the thermal management system 108 based on the data. In some implementations, for example, the thermal management system 108 may include one or more actuators 122. The actuators 122 may include pumps, valves, regulators, diverters, motors, or any other actuators designed or configured to control the flow of a fluid and/or a control of fans or air ducts or refrigeration circuits, such as compressors. For example, the thermal management system 108 may include at least one pump to circulate a coolant through the thermal management system 108. The thermal management system 108 may include various other components configured to modify a thermal condition of the battery pack 106 including, but not limited to, a heat exchanger, a radiator, phase change materials (PCMs), a chiller, a heater, or other components.

The BMS 102 may be configured to transmit and/or receive various information or signals to and/or from the BTMS 104. For example, the BMS 102 may be configured to transmit various metrics of the battery pack 106 to the BTMS 104 including, but not limited to, a current demand (e.g., electric current or power) for the battery pack 106, a resistance or approximate resistance of the battery pack 106, an estimated efficiency of the battery pack 106 (e.g., during a discharge state of the battery pack 106 or during a non-discharge state of the battery pack 106), a SOC of the battery pack 106, a SOH of the battery pack 106, and/or various other metrics of the battery pack 106. The BMS 102 may be configured to transmit various other data to the BTMS 104. For example, the BMS 102 may be communicably coupled to one or more ambient sensors 134 capable of monitoring ambient metrics of the system 100 including, but not limited to, an ambient temperature and an ambient pressure. The BMS 102 may be configured to transmit the ambient metrics to the BTMS 104. Additionally or alternatively, the BTMS 104 may be communicably coupled to the one or more ambient sensors 134 and may be configured to receive the ambient temperature and/or pressure directly from the sensors 134.

In some implementations, the BMS 102 and/or the BTMS 104 may be configured to determine or estimate a heat load for the battery pack 106, as described in greater detail herein. For example, in some implementations, the BTMS 104 may be configured to determine a heat load (e.g., heat dissipated by the battery pack 106) of the battery pack 106 responsive to receiving information (e.g., the metrics of the battery pack 106 and/or the ambient metrics) from the BMS 102. In some implementations, the BMS 102 may be configured to determine or estimate the heat load based on the metrics of the battery pack 106 and/or the ambient metrics and transmit the heat load to the BTMS 104. The BMS 102 and/or the BTMS 104 may be configured to apply the heat load to a threshold criteria (e.g., a setpoint). For example, BMS 102 and/or the BTMS 104 may be configured to determine whether the heat load exceeds a threshold. Responsive to applying the heat load to the threshold criteria, the BMS 102 may be configured to transmit a signal to the BTMS 104 to modify one or more components of the thermal management system 108 and/or the BTMS 104 may be configured to modify one or more components of the thermal management system 108, as described herein. In some implementations, the heat load may be an estimate based on data from a previous, present, or future time window of operation of the battery pack 106 and/or ambient metrics during a discharge state of the battery pack 106 as described herein. In some implementations, the heat load may be determined based on pre-defined present or future conditions of the battery pack 106 during a charge mode of the battery pack 106, as described herein.

The system 100 may include at least one additional thermal management system external to the battery pack 106, such as a vehicle component thermal management system 124. The vehicle component thermal management system 124 may be configured to monitor and/or modify a thermal condition of one or more various components external to or different from the battery pack 106 or cells 118 including, but not limited to, vehicle inverters, converters, onboard chargers, transmission components, engine components, motors, and/or various other components within a vehicle. In other words, the vehicle components thermal management system 124 may be a secondary thermal management system and may be configured to cool another component of a vehicle aside from the battery pack 106. The vehicle component thermal management system 124 may include least one processor 130 and memory 132. The processor(s) 130 and memory 132 may be similar or identical in configuration to the processor(s) 110 and memory 112 of the BMS 102 described above. The vehicle component thermal management system 124 may include at least one actuator 136. The actuators 136 may include pumps, valves, regulators, diverters, motors, or any other actuators designed or configured to control the flow of a fluid and/or a control of fans 128 or air ducts or refrigeration circuits, such as compressors.

The vehicle component thermal management system 124 may include at least one sensor 126 (e.g., temperature sensor, pressure sensor, etc.). The sensor(s) 126 may be configured to monitor a thermal condition (e.g., temperature and/or pressure) of the vehicle component communicably coupled to the vehicle component thermal management system 124 that the vehicle component thermal management system 124 is structured to thermally regulate (e.g., an inverter, etc.). The vehicle component thermal management system 124, via the one or more processors 130, may be configured to cause one or more fans 128 of the thermal management system 124, such as one or more fans, to increase fan speed, decrease fan speed, or turn off at least one fan 128 based on the data from the one or more sensors 126 and/or data from the BMS 102 or BTMS 104, as described herein. At least one of the fans 128 of the vehicle component thermal management system 124 may include a power electronics (PE) fan.

The system 100 may include various other sensors or other components configured to determine or detect conditions of the system 100 and/or the vehicle in which the system 100 operates. For example, the system 100 may include one or more sensors configured to determine a location of the vehicle (e.g., via a location sensor), a movement of the vehicle (e.g., via a motion detection sensor), and/or various other sensors.

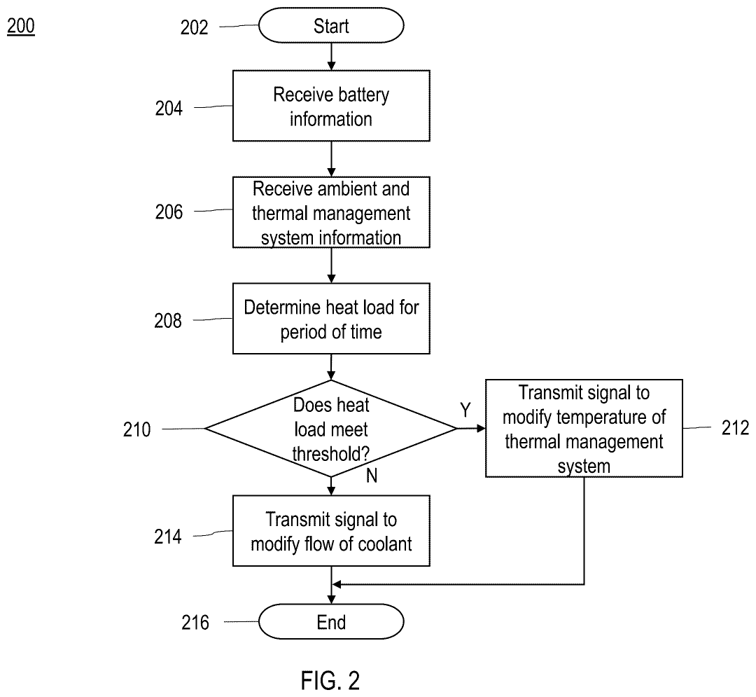

Referring now to FIG. 2, depicted is a flowchart showing an example process 200 of thermal management of the battery pack 106 using a predicted heat load. The process 200 may be performed by, implemented on, or otherwise executed by the components, elements, or hardware described above with reference to FIG. 1. For example, the process 200 may be executed by the system 100 of FIG. 1. While acts of the process 200 may be described herein as being performed by one part of the system 100 (e.g., the BMS 102), the various acts of the process 200 may be performed by various additional or alternative components of the system 100 or vehicle (e.g., the BTMS 104 or another component). In some implementations, the system 100 may be configured to perform or implement the process 200 during a discharge state of the battery pack 106 (e.g., as current flows from the battery pack 106 to another component, such as a load).

At act 202, the process 200 may begin. At act 204, one or more components of the system 100 may be configured to receive or determine information of the battery pack 106 through the one or more sensors or monitoring circuits of the battery pack 106. For example, the BMS 102 (e.g., via the one or more processors 110) may be configured to receive and/or determine information of the battery pack 106 including, but not limited to, a state of charge (SOC) of the battery pack 106, a voltage of the battery pack 106, an instantaneous current demand (e.g., electric current) of the battery pack 106, a time average current demand (e.g., electric current, which may be weighted by a square factor to capture head load end use as a function of current and resistance) of the battery pack 106 over a period of time, or a state of health (SOH) of the battery pack 106 (e.g., a state of performance or SOC, resistance rise, temperature, current, etc.). In some implementations, the BMS 102 may be configured to receive information of the battery pack 106 in real-time or near real-time. In some implementations, the BMS 102 may be configured to receive information of the battery pack 106 over a time window (e.g., over a previous, present, or future operating time window of the battery pack 106). For example, the BMS 102 may be configured to receive operational information of the battery pack 106 from the past (e.g., from the previous 15 seconds-10 minutes), for the present or near-present (e.g., from the previous 15 seconds-the future 15 seconds), or for the future (e.g., the future 15 seconds-10 minutes). For example, the BMS 102 may be configured to receive one or more of the SOC, change in SOC, or estimated future SOC, the voltage, change in voltage, or future voltage, the current demand, the change in current demand, or the future current demand, and/or the SOH, the change in SOH, or an estimated future SOH of the battery pack 106. In some implementations, the BMS 102 may be configured to transmit the information of the battery pack 106 to the BTMS 104 responsive to receiving the information.

At act 206, the BMS 102 (e.g., via the one or more processors 110) may be configured to receive ambient information and/or information regarding the thermal management system 108 of the battery pack 106 and/or of the battery pack 106. In some embodiments, the BMS 102 may be configured to receive the ambient information and/or information regarding the thermal management system 108 in real-time. For example, the BMS 102 may be configured to receive an ambient pressure and/or temperature from one or more ambient sensors 134 of the system 100 communicably coupled to the BMS 102. The BMS 102 may be configured to additionally or alternatively receive a temperature and/or pressure of a coolant or other information of the thermal management system 108 from the one or more sensors 120 of the thermal management system 108. In some implementations, the BMS 102 may be configured to transmit the ambient and/or thermal management system 108 information to the BTMS 104. In some implementations, the BTMS 104 may be configured to receive one or more of the ambient information and/or information regarding the thermal management system 108 of the battery pack 106 directly from the sensors 120, 134. The BMS 102 and/or the BTMS 104 may be configured to receive the ambient information during the same time window as the battery metrics received at act 206, or for a different time window. The BMS 102 and/or the BTMS 104 may be configured to additionally or alternatively detect or determine battery pack 106 ambient interaction properties, such as a surface area and a convective heat transfer coefficient.

At act 208, at least one of the BMS 102 and/or the BTMS 104 (e.g., via the one or more processors 110, 114) may be configured to determine an estimated heat load for another time window (e.g., a future time window) based on the information of the battery pack 106 of the previous, present, or future time window received at act 204 and/or based on the ambient and coolant information received at act 206. For example, the BMS 102 and/or the BTMS 104 may be configured to predict a heat load of the battery pack 106 for a future time window (e.g., the next 15 seconds-10 minutes) as a function of estimated future current demand, resistance, and efficiency of the battery pack 106 based on the received information of the battery pack 106 and the ambient information. In some implementations, the current and/or resistance of the battery pack 106 may be a fixed value. In some implementations, the current and/or resistance of the battery pack 106 may vary and/or be determined based on the information received by the BMS 102 from the battery pack 106. As an illustrative non-limiting example, the BMS 102 and/or the BTMS 104 may be configured to determine or receive information indicating that the SOC and/or the voltage of the battery pack 106 will steadily decrease over the future time window or that the SOC and/or voltage of the battery pack 106 has decreased over a previous time window. Based on this information, the BMS 102 and/or the BTMS 104 may be configured to predict a future heat load as a function of the current demand and resistance of the battery pack 106 in view of an estimated efficiency of the battery pack 106. In some implementations, the BMS 102 and/or the BTMS 104 may be configured to determine the estimated future heat load while the BMS 102 is configured to simultaneously regulate a current demand for the battery pack 106 during the discharge of the battery pack 106.

In some implementations, the BMS 102 and/or the BTMS 104 may be configured to predict a future heat load using various other information from the system 100. For example, the BMS 102 and/or the BTMS 104 may be configured to receive or determine dispatch and/or off-board information, including an upcoming charge event, standby time, a high load factor (e.g., uphill) haul, etc., an expected upcoming power (e.g., machine, battery, heat load) over a window that could be used to proactively control the thermal management system 108, or a wakeup call for a machine on standby or extended idle to either heat or cool to an operating temperature. As another example, the BMS 102 and/or the BTMS 104 may be configured to receive or determine information from machine sensors recognizing a charge, such as charge cables being connected (but not yet transferring energy), or a charge receptacle door open or operator cab switch position to charge interlock. As another example, the BMS 102 and/or the BTMS 104, or another components of the vehicle, may be configured to use machine learning based on past cycles and based on time history trends or GPS location trends for an anticipated heat load.

At act 210, the BMS 102 and/or the BTMS 104 (e.g., via the one or more processors 110, 114) may be configured to determine whether the estimated heat load satisfies a threshold. For example, the BMS 102 and/or the BTMS 104 may be configured to compare the estimated heat load to a threshold. The threshold may be a predetermined and/or fixed threshold value or condition based on, for example, one or more conditions of the battery pack 106, system 100, and/or vehicle. The threshold may alternatively or additionally vary based on the information of the battery pack 106, ambient metrics, and/or information of the thermal management system 108. For example, the threshold may be determined based on a desired lifetime and/or performance metric of the battery pack 106. In some implementations, the BMS 102 and/or the BTMS 104 may be configured to determine whether the estimated heat load meets the threshold while regulating a current demand for the battery pack 106 during the discharge of the battery pack 106. In some implementations, the BMS 102 and/or the BTMS 104 may be configured to determine whether one or more ambient metrics of the system 100 satisfies a threshold.

Where the BMS 102 and/or the BTMS 104 (e.g., via the one or more processors 110, 114) determine that the estimated future heat load meets or exceeds the threshold, the BMS 102 and/or the BTMS 104 may be configured to modify a condition of the thermal management system 108 by, for example, decreasing a temperature of a coolant and/or modifying a heat transfer of the thermal management system 108 at act 212. For example, in some implementations, the BMS 102 may be configured to transmit a signal to the BTMS 104 to cause the thermal management system 108 to decrease a temperature of a coolant (e.g., between 15° C. to 25° C., or within another temperature range). In some implementations, the BTMS 104 may be configured to cause the thermal management system 108 to decrease a temperature of a coolant responsive to determining the heat load meets the threshold. In some implementations, the BMS 102 and/or the BTMS 104 may be configured to cause the thermal management system 108 to decrease a temperature of the coolant while regulating a current demand for the battery pack 106 during the discharge of the battery pack 106. Such configurations allow the BTMS 104 and the thermal management system 108 to increase the cooling of the battery pack 106 or overcool the battery pack 106 based on the estimated heating demand exceeding the threshold, thus increasing the overall lifetime and performance of the battery pack 106. The BMS 102 and/or the BTMS 104 may be configured to modify various other conditions of the thermal management system 108 including, for example, modifying operation of one or more chillers, fans, heaters, compressors, pumps, refrigeration systems, or various other components that may cause a change in temperature of a coolant or other medium of the thermal management system 108. For example, modifying the temperature of the coolant may comprise modifying the heat rejection of the thermal management system and subsequent cooling medium. In some implementations, the BMS 102 and/or the BTMS 104 may be configured to modify the thermal management system 108 based on the ambient metrics of the system 100, even where the predicted heat load is minimum or zero. For example, the threshold may be based on the heat load and/or the ambient metrics, such that the lead load of the battery pack 106 may exceed the threshold based solely on one or more ambient metrics (e.g., such that the battery pack 106 may be cooled depending on the ambient temperature meeting a threshold and/or the heat load meeting a threshold).

Where the BMS 102 and/or the BTMS 104 (e.g., via the one or more processors 110, 114) determine that the estimated future heat load does not exceed the threshold, the BMS 102 and/or the BTMS 104 may be configured to modify the thermal management system 108 as needed or maintain the thermal management system 108 as is, at act 214. For example, in some implementations, the BMS 102 may be configured to transmit a signal to the BTMS 104 to cause the thermal management system 108 to modify a flow rate of a coolant through the thermal management system 108 (e.g., start a flow of coolant, stop a flow of coolant, increase a flow of coolant, etc.). In some implementations, the BTMS 104 may be configured to cause the thermal management system 108 to modify the flow of coolant responsive to determining the heat load does not meet the threshold. In some implementations, the BMS 102 and/or the BTMS 104 may be configured to cause the thermal management system 108 to modify a flow of the coolant while regulating a current demand for the battery pack 106 during the discharge of the battery pack 106. In some implementations, the BMS 102 and/or the BTMS 104 may be configured to cause the thermal management system 108 to maintain a flow of coolant (e.g., without modification). For example, in some implementations, the BMS 102 and/or the BTMS 104 may be configured to cause the thermal management system 108 to modify or maintain the coolant temperature and/or flow rate based on a signal or reading of the one or more sensors 120 of the thermal management system 108. The process 200 may be configured to end or restart at act 216.

The process 200 of communicating the current demands of the battery pack 106 from the BMS 102 to the BTMS 104 so that the BTMS 104 can activate the thermal management system 108 earlier (e.g., prior to a temperature sensor of the battery pack 106 indicating a high or low heat) and/or decrease the temperature of the coolant allows the system 100 to cool the battery pack 106 harder than conventional techniques in which the thermal management system 108 is only activated responsive to a temperature reading of the battery pack 106 itself (e.g., without considering the past, future, or present battery demands). Such implementation facilitates extending the overall lifetime of the battery pack 106 and/or increasing performance of the battery pack 106 by decreasing the time it takes for the thermal management system 108 to regulate a temperature of the battery pack 106.

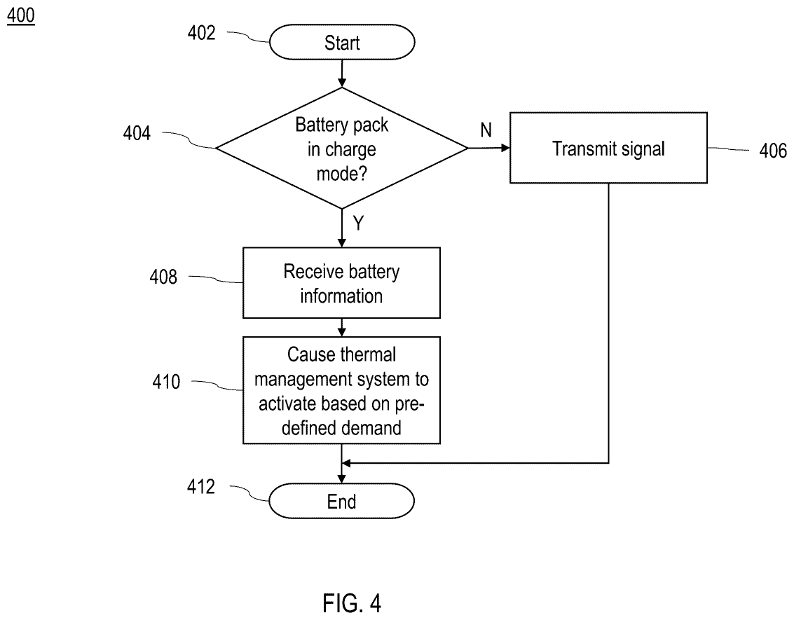

Referring now to FIG. 4, depicted is a flowchart showing an example process 400 of enhancing thermal management of the battery pack 106 using a pre-determined heat load during a charge event. The process 400 may be performed by, implemented on, or otherwise executed by the components, elements, or hardware described above with reference to FIG. 1. For example, the process 400 may be executed by the system 100 of FIG. 1. While acts of the process 400 may be described herein as being performed by one part of the system 100 (e.g., the BMS 102), the various acts of the process 400 may be performed by various additional or alternative components of the system 100 or vehicle (e.g., the BTMS 104 or another component). In some implementations, the system 100 may be configured to perform or implement the process 400 during a charge event or state of the battery pack 106 (e.g., as current flows into the battery pack 106 to be stored as energy). In some implementations, a charge event may include an anticipated future event with a high heat load such as braking regeneration, static charging, or motivate charging.

At act 402, the process 400 may begin. At act 404, one or more components of the system 100 may be configured to determine whether the battery pack 106 is in a charging mode. For example, the BMS 102 (e.g., via the one or more processors 110) may be configured to determine or detect that the battery pack 106 is in a charging mode based on, for example, information (e.g., voltage, current, etc.) from a sensor of the battery pack 106, through communication with a charging device (e.g., via various protocols like a CAN bus and/or during a handshake process), and/or through a determination of a SOC increase based on voltage, current, and/or a time parameter of the battery pack 106.

Where the BMS 102 (e.g., via the one or more processors 110) determines that the battery pack 106 is in a charge mode, the BMS 102 and/or the BTMS 104 may be configured to receive information about the battery pack 106 at act 408. For example, the information of the battery pack 106 may include, but is not limited to, a SOC of the battery pack 106, a voltage of the battery pack 106, an instantaneous charge current, or a SOH of the battery pack 106. The information may be based on a present or near-present operating condition of the battery pack 106, or the information may be based on a previous operating time window or future operating time window, as described herein. The BMS 102 and/or the BTMS 104 may additionally or alternatively be configured to receive information of the thermal management system 108, such as a temperature of pressure of a coolant, and/or ambient information, such as a temperature and pressure.

At act 410, the BMS 102 and/or the BTMS 104 (e.g., via the one or more processors 110, 114) may be configured to cause the thermal management system 108 to activate based on a pre-defined or predetermined cooling demand for the battery pack 106 responsive to determining the battery pack 106 is in a charge mode and/or receiving the information of the battery pack 106. For example, in some implementations, the BMS 102 and/or the BTMS 104 may be configured to map the charging rate, current, resistance, and/or voltage during the charge event to a corresponding heat load for the battery pack 106. In other words, the BMS 102 may be configured to control a pre-defined charging voltage and current through the battery pack 106 based on the SOC and may be configured to map the pre-defined charging voltage and current to an accurately estimated heat load. For example, when in a charge mode, based on the ambient temperature and battery information, the optimal thermal management system 108 operation is known (e.g., based on the charge current the voltage).

In some implementations, the BMS 102 may be configured to transmit the pre-defined charging voltage and current to the BTMS 104 and the BTMS 104 may be configured to determine the heat load of the battery pack 106 for the immediate time instance and/or for a future time window (e.g., the future 15 seconds to 10 minutes) based on the pre-defined charging voltage and current. Responsive to receiving the pre-defined heat load or determining the pre-defined heat load, the BTMS 104 may be configured to modify or adjust the thermal management system 108 accordingly based on the determined heat load. In some implementations, since the charging rate and/or profile (e.g., voltage, current, etc.) may be pre-defined based on the charging state, the BTMS 104 may be configured to modify the cooling command of the thermal management system 108 in a pre-defined manner or in a pre-defined static map. Mapping the charging operation to a cooling demand via the BTMS 104 allows for a significantly simplified control logic and better cooling results from the thermal management system 108 as compared to conventional techniques.

Where the BMS 102 (e.g., via the one or more processors 110) determines that the battery pack 106 is not in a charge mode, the BMS 102 may be configured to transmit one or more signals to the BTMS 104 at act 406. For example, the BMS 102 may be configured to transmit a signal to the BTMS 104 indicating to continue operating the thermal management system 108 as-is. As another example, the BMS 102 may be configured to transmit a signal to the BTMS 104 indicating to not operate the thermal management system 108. The process 400 may be configured to end or restart at act 412.

In some implementations, the process 400 may additionally or alternatively include pre-conditioning the battery pack 106 based on an upcoming or predicted charge event. For example, the BMS 102 and/or the BTMS 104 (e.g., via the one or more processors 110, 114) may be configured to detect an upcoming charge event. The BMS 102 and/or the BTMS 104 may be configured to detect an upcoming charging event through various sensors or controllers throughout the system 100 indicating an initiation of a charge event. For example, the BMS 102 and/or the BTMS 104 may be configured to receive a signal from an offboard dispatching service of the system 100 indicating that a charging event will occur in within a predetermined period of time. The BMS 102 and/or the BTMS 104 may be configured to receive a signal from a sensor that a physical condition of the system 100 indicating that a charge event will occur within a predetermined period of time, such as a door of a charge port within the system 100 being opened, as another example. The BMS 102 and/or the BTMS 104 may be configured to receive a signal from a Global Positioning System (GPS) or other location sensor indicating the system 100 or vehicle is within a GPS fence based on configured charging locations or historical charging locations stored in memory. Responsive to detecting that a charge event will occur within a future time window, the BMS 102 and/or the BTMS 104 may be configured to cause the thermal management system 108 to start a flow of coolant and/or decrease a temperature of the coolant (e.g., between 15° C. to 18° C., or within another temperature range) to pre-cool the battery pack 106 in anticipation of the charge event. Such implementation minimizes a fluctuation in temperature of the battery pack 106 and/or reduces the maximum temperature of the battery pack 106 reached during a charge event to increase the lifetime and/or performance of the battery pack 106. In some implementations, the process 400 may include one or more additional or alternative acts of the process 200. For example, the process 400 may include causing the thermal management system 108 to decrease a temperature of a coolant responsive to a heat load being greater than or equal to a threshold.

The process 400 of using pre-defined metrics of the battery pack 106 during a charging event to determine a heat load of the battery pack 106 allows the BMS 102 and the BTMS 104 to more efficiently cool the battery pack 106 as compared to conventional techniques. For example, the process 400 may cool the battery pack 106 faster than if the thermal management system 108 were activated only responsive to a temperature reading of the battery pack 106 itself. Such implementation facilitates extending the overall lifetime of the battery pack 106 and/or increasing performance of the battery pack 106 by decreasing the time it takes for the thermal management system 108 to regulate a temperature of the battery pack 106 during a charge event of the battery pack 106. Moreover, the processing power and time of the system 100 is decreased as compared to conventional techniques because less power may be used to effectively cool the battery pack 106 during a charging event.

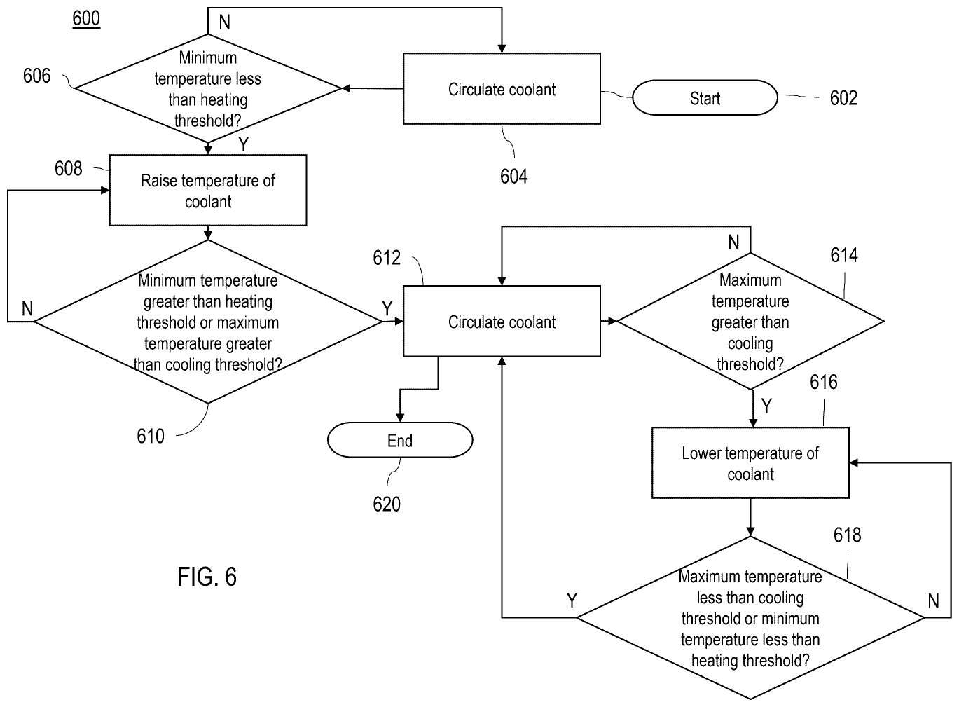

Referring now to FIG. 6, depicted is a flowchart showing an example process 600 of enhancing thermal management of the battery pack 106 based on a thermal condition of one or more battery cells 118 of the battery pack 106. The process 600 may be performed by, implemented on, or otherwise executed by the components, elements, or hardware described above with reference to FIG. 1. For example, the process 600 may be executed by the system 100 of FIG. 1. While acts of the process 600 may be described herein as being performed by one part of the system 100 (e.g., the BMS 102), the various acts of the process 600 may be performed by various additional or alternative components of the system 100 or vehicle (e.g., the BTMS 104 or another component).

At act 602, the process 600 may begin. At act 604, one or more components of the system 100 may be configured to circulate a coolant through the battery pack 106. For example, the BTMS 104 (e.g., via the one or more processors 114) may be configured to cause the thermal management system 108 to circulate a coolant through various channels, pipes, or lines of the thermal management system 108 to cool or heat the battery cells 118 of the battery pack 106.

At act 606, the BTMS 104 (e.g., via the one or more processors 114) may be configured to determine whether a minimum temperature of one or more battery cells 118 is less than a heating threshold of the battery pack 106. For example, the BTMS 104 may be configured to determine, based on one or more sensors 120 of the thermal management system 108, that a battery cell 118 of the plurality of battery cells 118 has a temperature that is a minimum of all of the plurality of battery cells 118 and is less than a heating threshold. In other words, the BTMS 104 may be configured to determine when any battery cell 118 has a temperature that is below a threshold to activate heating the battery cells 118 of the battery pack 106. In some implementations, the BTMS 104 may alternatively or additionally be configured to determine whether an average temperature of the battery cells 118 is less than a heating threshold.

Where the BTMS 104 determines that a minimum temperature of the battery cells 118 is greater than the heating threshold, the BTMS 104 may continue to cause the thermal management system 108 to circulate a coolant at act 604. Where the BTMS 104 determines that a minimum temperature of the battery cells 118 is less than the heating threshold, the BTMS 104 (e.g., via the one or more processors 114) may be configured to cause the thermal management system 108 to raise the temperature of the coolant flowing through the thermal management system 108, or modify another condition of the thermal management system 108, to heat the one or more battery cells 118 of the battery pack 106 at act 608.

At act 610, the BTMS 104 (e.g., via the one or more processors 114) may be configured to determine whether a minimum temperature of one or more battery cells 118 is greater than a heating threshold of the battery pack 106 or whether a maximum temperature of one or more battery cells 118 is greater than a cooling threshold. For example, the BTMS 104 may be configured to determine, based on one or more sensors 120 of the thermal management system 108, that a battery cell 118 of the plurality of battery cells 118 has a temperature that is a minimum of all of the plurality of battery cells 118 and is greater than a heating threshold or that a battery cell 118 of the plurality of battery cells 118 has a temperature that is a maximum of all of the plurality of battery cells 118 and is greater than a cooling threshold. In other words, the BTMS 104 may be configured to determine when any battery cell 118 has a temperature that is above a threshold to stop heating the battery cells 118 and/or a temperature that is above a threshold to activate cooling the battery cells 118 of the battery pack 106. In some implementations, the BTMS 104 may alternatively or additionally be configured to determine whether an average temperature of the battery cells 118 reaches the cooling and/or heating threshold.

Where the BTMS 104 determines that a minimum temperature of the battery cells 118 does not exceed the heating threshold and/or that a maximum temperature of the battery cells 118 does not exceed the cooling thresholding, the BTMS 104 may continue to cause the thermal management system 108 to raise the temperature of the coolant and/or modify a heat transfer at act 608. Where the BTMS 104 determines that a minimum temperature of the battery cells 118 does exceed the heating threshold and/or that a maximum temperature of the battery cells 118 does exceed the cooling thresholding, the BTMS 104 (e.g., via the one or more processors 114) may be configured cause the thermal management system 108 to stop raising the temperature of the coolant and/or circulate the coolant at act 612.

At act 614, the BTMS 104 (e.g., via the one or more processors 114) may be configured to determine whether a maximum temperature of the battery cells 118 is greater than a cooling threshold. For example, the BTMS 104 may be configured to determine, based on one or more sensors 120 of the thermal management system 108, that a battery cell 118 of the plurality of battery cells 118 has a temperature that is a maximum of all of the plurality of battery cells 118 and is greater than a cooling threshold. In other words, the BTMS 104 may be configured to determine when any battery cell 118 has a temperature that is above a threshold to activate cooling the battery cells 118 of the battery pack 106. In some implementations, the BTMS 104 may alternatively or additionally be configured to determine whether an average temperature of the battery cells 118 is greater than the cooling threshold.

Where the BTMS 104 determines that a maximum temperature of the battery cells 118 does not exceed the cooling thresholding, the BTMS 104 may continue to circulate the coolant at act 612. Where the BTMS 104 determines that a maximum temperature of the battery cells 118 does exceed the cooling thresholding, the BTMS 104 (e.g., via the one or more processors 114) may be configured cause the thermal management system 108 to lower the temperature of the coolant, or modify another condition of the thermal management system 108, at act 616.

At act 618, the BTMS 104 (e.g., via the one or more processors 114) may be configured to determine whether a maximum temperature of the battery cells 118 is less than a cooling threshold and/or whether a minimum temperature is less than a heating threshold. For example, the BTMS 104 may be configured to determine, based on one or more sensors 120 of the thermal management system 108, that a battery cell 118 of the plurality of battery cells 118 has a temperature that is a maximum of all of the plurality of battery cells 118 and is less than a cooling threshold and/or that a battery cell 118 of the plurality of battery cells 118 is a maximum of the battery cells 118 and is less than a heating threshold. In other words, the BTMS 104 may be configured to determine when any battery cell 118 has a temperature that is below a threshold to activate cooling the battery cells 118 and/or below a threshold to activate heating the battery cells 118 of the battery pack 106. In some implementations, the BTMS 104 may alternatively or additionally be configured to determine whether an average temperature of the battery cells 118 reaches the cooling and/or heating threshold.

Where the BTMS 104 determines that a maximum temperature of the battery cells 118 is not less than the cooling thresholding and/or a minimum temperature of the battery cells 118 is not less than the heating threshold, the BTMS 104 may continue to lower the temperature of the coolant at act 616. Where the BTMS 104 determines that a maximum temperature of the battery cells 118 is less than the cooling thresholding and/or that a minimum temperature of the battery cells 118 is less than a heating threshold, the BTMS 104 (e.g., via the one or more processors 114) may be configured cause the thermal management system 108 to circulate the coolant at act 612. The process 600 may be configured to end or restart at act 620. In some implementations, the process 600 may additionally or alternatively include decreasing the heat load or rejection from the battery pack 106, by focusing on supplying thermal management (e.g., heat removal and/or addition) and demand of the battery pack 106 (e.g., battery temperature and/or heat load).

The process 600 of using a temperature measurement of one or more battery cells 118 and/or of an average temperature of the battery cells 118 to determine whether a temperature of the coolant should be modified allows the BTMS 104 to more efficiently cool the battery pack 106 as compared to conventional techniques. For example, the process 600 may regulate a temperature of the battery pack 106 more efficiently than if the BTMS 104 were to determine whether a temperature of the coolant should be modified based on a temperature of the coolant itself (e.g., as opposed to the one or more battery cells 118). Such implementation also increases the rate at which heat is exchanged between the battery cell(s) 118 and the coolant based on the BTMS 104 determining a temperature of the coolant responsive to a temperature of one or more battery cells 118 reaching a threshold. For example, the rate of heat exchange is based on a product of a difference in temperature between the one or more battery cells 118 and the coolant.

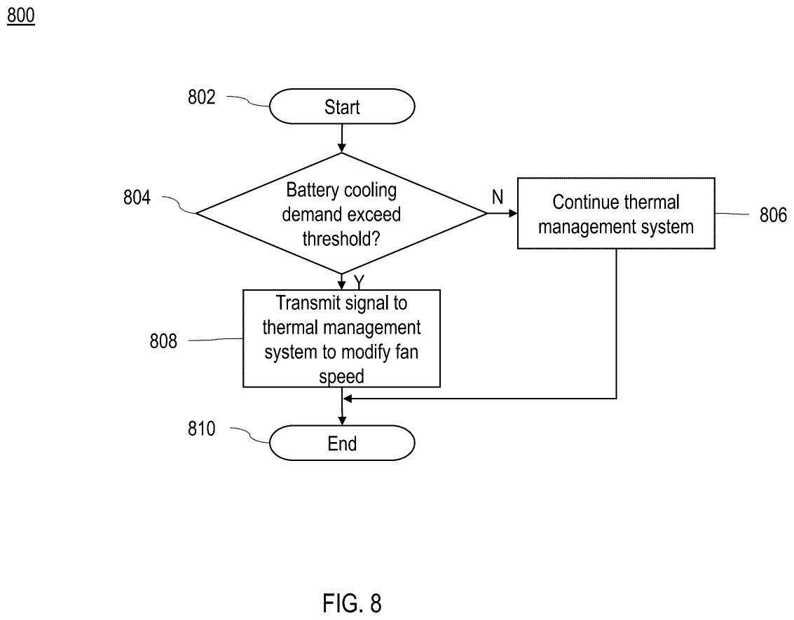

Referring now to FIG. 8, depicted is a flowchart showing an example process 800 of enhancing thermal management of a battery pack 106 by modifying a secondary thermal management system of a vehicle (e.g., the vehicle component thermal management system 124). The process 800 may be performed by, implemented on, or otherwise executed by the components, elements, or hardware described above with reference to FIG. 1. For example, the process 800 may be executed by the system 100 of FIG. 1. While acts of the process 800 may be described herein as being performed by one part of the system 100 (e.g., the BMS 102), the various acts of the process 800 may be performed by various additional or alternative components of the system 100 or vehicle (e.g., the BTMS 104 or another component).

At act 802, the process 800 may begin. At act 804, one or more components of the system 100 may be configured to determine whether a battery pack 106 cooling demand exceeds a threshold. For example, the BMS 102 and/or the BTMS 104 (e.g., via the one or more processors 114) or another control unit of the vehicle may be configured to determine, based on one or sensors 120 of the battery pack 106 and/or based on a predicted or pre-defined heat load determined according to the processes described herein, whether a cooling demand for the battery pack 106 meets a threshold value. In some implementations, the BMS 102 and/or the BTMS 104 may be configured to additionally or alternatively determine whether the battery pack 106 is in a charging event and/or whether the system 100 is stationary based on one or more sensors (e.g., motion sensors) throughout the system 100.

Where the BMS 102 and/or the BTMS 104 determines that a cooling demand of the battery pack 106 does not exceed the threshold, the BMS 102 and/or the BTMS 104 may be configured to cause the vehicle component thermal management system 124 to continue cooling the vehicle component communicably coupled to the vehicle component thermal management system 124 at act 806. For example, the BMS 102 and/or the BTMS 104 may be configured to transmit a signal to the vehicle component thermal management system 124 to continue cooling the vehicle component.

Where the BMS 102 and/or the BTMS 104 determines that a cooling demand of the battery pack 106 does exceed the threshold, the BMS 102 and/or the BTMS 104 (e.g., via the one or more processors 110, 114) may be configured to cause the vehicle component thermal management system 124 to modify a fan speed of the one or more fans 128 of the vehicle component thermal management system 124 at act 808. For example, the BMS 102 and/or the BTMS 104 may be configured to transmit a signal to the vehicle component thermal management system 124 to modify a fan speed of the fans 128. In some implementations, the vehicle component thermal management system 124 may be configured to modify a plurality of fans 128 at the same time. In some implementations, the vehicle component thermal management system 124 may be configured to modify one fan 128 of a plurality of the fans 128 or a subset of fans 128 of the plurality of fans 128. In some implementations, the vehicle component thermal management system 124 may be configured to modify one or more of the fans 128 by causing at least one of the fans 128 to stop (e.g., cause the fan speed of at least one fan 128 to be equal to 0 RPM), by causing at least one of the fans 128 to decrease in fan speed (e.g., cause the fan speed of at least one fan 128 to be greater than 0 RPM), and/or by causing at least one of the fans 128 to increase in fan speed. The vehicle component thermal management system 124 may be configured to modify a first subset of the fans 128 to a first fan speed (e.g., a minimum fan speed) and a second subset of the fans 128 to a second fan speed (e.g., 0 RPM). The process 800 may be configured to end or restart at act 810. In some implementations, the BMS 102 and/or the BTMS 104 may be configured to cause the vehicle component thermal management system 124 to modify a fan speed of the one or more fans 128 responsive to determining that the battery pack 106 is undergoing a charge event.

The process 800 of selectively modifying a secondary vehicle component thermal management system 124 while the battery thermal management system 108 is running may facilitate increasing the efficiency of the thermal management system 108 by reducing recirculation of any potential warm air throughout the system 100. In other words, the BMS 102 and/or the BTMS 104 may be configured to cause the vehicle component thermal management system 124 to modify the fan speed of the fan(s) 128 to prioritize cooling of the battery pack 106 (e.g., when the battery pack 106 is undergoing a charging event or during another period of time) as compared to, for example, the vehicle component that the vehicle component thermal management system 124 is configured to cool. For example, modifying the fan speed of the fans 128 and/or turning off one or more fans 128 may facilitate reducing recirculation of any potential warm air throughout the system 100, which may interfere with or impact the effectiveness of the battery thermal management system 108. Therefore, selectively decreasing fan speed of the fans 128 of the secondary vehicle component thermal management system 124 may make the thermal management system 108 of the battery pack 106 more efficient.

### INDUSTRIAL APPLICABILITY

The disclosed embodiments may be applicable to any battery-based system or solution. For example, the disclosed embodiments may be applicable to or applied to a vehicle as described herein, such as an automobile, heavy machinery, or any other type of vehicle, a power source for a home, office, or any other residential/industrial setting, or any other power delivery system which may be powered by a battery pack. The disclosed embodiments may be applicable to battery-based systems which use or include one or more thermal management systems configured to regulate a temperature of the battery pack or other components during operation of the system.

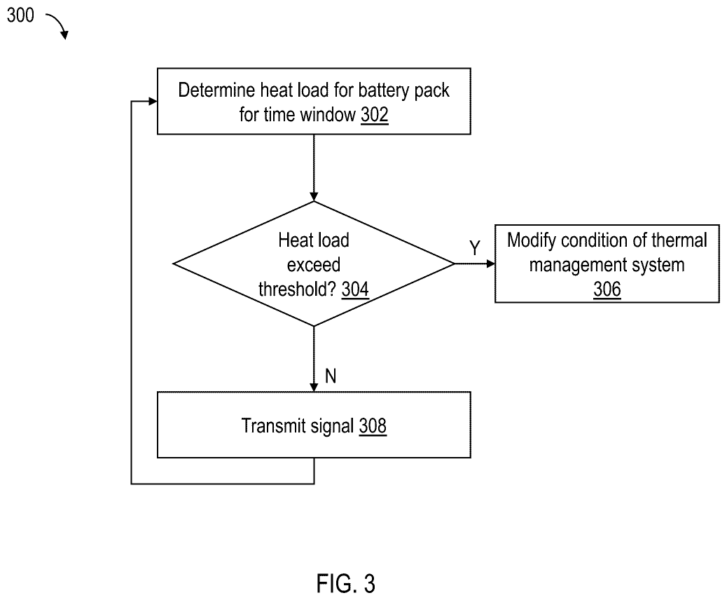

Referring now to FIG. 3, depicted is a flowchart showing an example method 300 of enhancing thermal management of the battery pack 106 using a predicted heat load. The method 300 may be performed by, implemented on, or otherwise executed by the components, elements, or hardware described above with reference to FIG. 1. For example, the method 300 may be executed by the system 100 of FIG. 1. While steps of the method 300 may be described herein as being performed by one part of the system 100 (e.g., the BMS 102), the various steps of the method 300 may be performed by various additional or alternative components of the system 100 or vehicle (e.g., the BTMS 104 or another component). In some implementations, the system 100 may be configured to perform or implement the method 300 during a discharge state of the battery pack 106 (e.g., as current flows from the battery pack 106 to another component, such as a load).

At step 302, at least one of the BMS 102 and/or the BTMS 104 may determine an estimated heat load for a future time window based on information of the battery pack 106 of a previous, present, or future time window. For example, the BMS 102 and/or the BTMS 104 may predict a heat load of the battery pack 106 for a future time window (e.g., the next 15 seconds-10 minutes) as a function of estimated future current demand, resistance, and efficiency of the battery pack 106 based on the received information of the battery pack 106 and the ambient information as described in greater detail with reference to FIG. 2. In some implementations, the current and/or resistance of the battery pack 106 may be a fixed value. In some implementations, the current and/or resistance of the battery pack 106 may vary and/or be determined based on the information received by the BMS 102 from the battery pack 106. As an illustrative non-limiting example, the BMS 102 and/or the BTMS 104 may determine or receive information indicating that the SOC and/or the voltage of the battery pack 106 will steadily decreasing over the future time window or that the SOC and/or voltage of the battery pack 106 has decreased over a previous time window. Based on this information, the BMS 102 and/or the BTMS 104 may predict a future heat load as a function of the current demand and resistance of the battery pack 106 in view of an estimated efficiency of the battery pack 106 and/or in view of the ambient conditions and coolant conditions. In some implementations, the BMS 102 and/or the BTMS 104 may determine the estimated future heat load while the BMS 102 simultaneously regulates a current demand for the battery pack 106 during the discharge of the battery pack 106.

At step 304, the BMS 102 and/or the BTMS 104 may determine whether the estimated heat load exceeds a threshold. For example, BMS 102 and/or the BTMS 104 may compare the estimated heat load to a threshold. The threshold may be a predetermined and/or fixed threshold value or condition based on, for example, one or more conditions of the battery pack 106, system 100, and/or vehicle. The threshold may alternatively or additionally vary based on the information of the battery pack 106, ambient metrics, and/or information of the thermal management system 108. For example, the threshold may be determined based on a desired lifetime and/or performance metric of the battery pack 106. In some implementations, the BMS 102 and/or the BTMS 104 may determine whether the estimated heat load meets the threshold while regulating a current demand for the battery pack 106 during the discharge of the battery pack 106.

Where the BMS 102 and/or the BTMS 104 determine that the estimated future heat load exceeds the threshold, the BMS 102 and/or the BTMS 104 may modify a condition of the thermal management system 108 by, for example, decreasing a temperature of a coolant and/or modifying a heat transfer of the thermal management system 108 at step 306. For example, in some implementations, the BMS 102 may transmit a signal to the BTMS 104 to cause the thermal management system 108 to decrease a temperature of a coolant (e.g., between 15° C. to 18° C., or within another temperature range). In some implementations, the BTMS 104 may transmit a signal to the thermal management system 108 to cause the thermal management system 108 to decrease a temperature of a coolant responsive to determining the heat load meets the threshold. In some implementations, the BMS 102 and/or the BTMS 104 may cause the thermal management system 108 to decrease a temperature of the coolant while regulating a current demand for the battery pack 106 during the discharge of the battery pack 106. Such configurations allow the BTMS 104 and the thermal management system 108 to increase the cooling of the battery pack 106 or overcool the battery pack 106 based on the estimated heating demand exceeding the threshold, thus increasing the overall lifetime and performance of the battery pack 106. The BMS 102 and/or the BTMS 104 may to modify various other conditions of the thermal management system 108 including, for example, modifying operation of one or more chillers, fans, heaters, compressors, pumps, refrigeration systems, or various other components that may cause a change in temperature of a coolant or other medium of the thermal management system 108. For example, modifying the temperature of the coolant may comprise modifying the heat rejection of the thermal management system and subsequent cooling medium. In some implementations, the BMS 102 and/or the BTMS 104 may modify the thermal management system 108 based on the ambient metrics of the system 100, even where the predicted heat load is minimum or zero. For example, the threshold may be based on the heat load and/or the ambient metrics, such that the lead load of the battery pack 106 may exceed the threshold based solely on one or more ambient metrics (e.g., such that the battery pack 106 may be cooled depending on the ambient temperature meeting a threshold and/or the heat load meeting a threshold).

Where the BMS 102 and/or the BTMS 104 determine that the estimated future heat load does not exceed the threshold, the BMS 102 and/or the BTMS 104 may modify the thermal management system as needed or maintain the thermal management system 108 as is at step 308. For example, in some implementations, the BMS 102 may transmit a signal to the BTMS 104 to cause the thermal management system 108 to modify a flow rate of a coolant through the thermal management system 108 (e.g., start a flow of coolant, stop a flow of coolant, increase a flow of coolant, etc.). In some implementations, the BTMS 104 may transmit a signal to the thermal management system 108 to cause the thermal management system 108 to modify the flow of coolant responsive to determining the heat load does not meet the threshold. In some implementations, the BMS 102 and/or the BTMS 104 may cause the thermal management system 108 to modify a flow of the coolant while regulating a current demand for the battery pack 106 during the discharge of the battery pack 106. In some implementations, the BMS 102 and/or the BTMS 104 may cause the thermal management system 108 to maintain a flow of coolant (e.g., without modification). For example, in some implementations, the BMS 102 and/or the BTMS 104 may cause the thermal management system 108 to modify or maintain the coolant temperature and/or flow rate based on a signal or reading of the one or more sensors 120 of the thermal management system 108. The method 300 may restart by determining another heat load for the battery pack 106 for a new time window at step 302.

The method 300 of communicating the current demands of the battery pack 106 from the BMS 102 to the BTMS 104 so that the BTMS 104 can activate the thermal management system 108 earlier (e.g., prior to a temperature sensor of the battery pack 106 indicating a high or low heat) and/or decrease the temperature of the coolant allows the system 100 to cool the battery pack 106 harder than conventional techniques in which the thermal management system 108 is only activated responsive to a temperature reading of the battery pack 106 itself (e.g., without considering the past, future, or present battery demands). Such implementation facilitates extending the overall lifetime of the battery pack 106 and/or increasing performance of the battery pack 106 by decreasing the time it takes for the thermal management system 108 to regulate a temperature of the battery pack 106.

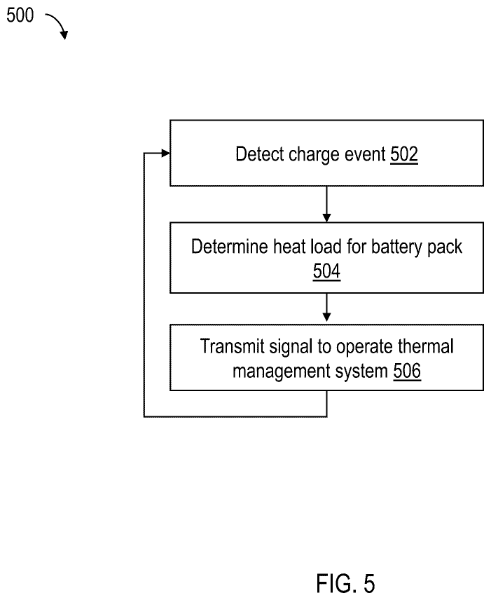

Referring now to FIG. 5, depicted is a flowchart showing an example method 500 of enhancing thermal management of the battery pack 106 using a pre-determined heat load during a charge event. The method 500 may be performed by, implemented on, or otherwise executed by the components, elements, or hardware described above with reference to FIG. 1. For example, the method 500 may be executed by the system 100 of FIG. 1. While steps of the method 500 may be described herein as being performed by one part of the system 100 (e.g., the BMS 102), the various steps of the method 500 may be performed by various additional or alternative components of the system 100 or vehicle (e.g., the BTMS 104 or another component). In some implementations, the system 100 may be configured to perform or implement the method 500 during a charge event or state of the battery pack 106 (e.g., as current flows into the battery pack 106 to be stored as energy).

At step 502, the BMS 102, or another component of the system 100, may determine or detect a charge event for the battery pack 106 based on, for example, information (e.g., voltage, current, etc.) from a sensor of the battery pack 106, through communication with a charging device (e.g., via various protocols like a CAN bus and/or during a handshake process), and/or through a determination of a SOC increase based on voltage, current, and/or a time parameter of the battery pack 106.

At step 504, the BMS 102 and/or the BTMS 104 may determine a heat load for the battery pack 106 based on various charging parameters or conditions of the battery pack 106. For example, in some implementations, the BMS 102 and/or the BTMS 104 may map a charging rate (e.g., current, voltage, etc.) of the battery pack 106 to a pre-defined corresponding heat load for the battery pack 106. In other words, the BMS 102 may control a pre-defined charging voltage and current through the battery pack 106 based on a SOC of the battery pack 106 and may map the pre-defined charging voltage and current to a known heat load. In some implementations, the BMS 102 may transmit the pre-defined charging voltage and current to the BTMS 104 and the BTMS 104 may determine the heat load of the battery pack 106 for the immediate time instance and/or for a future time window (e.g., the future 15 seconds to 10 minutes) based on the pre-defined charging voltage and current.

At step 506, the BMS 102 and/or the BTMS 104 may cause the thermal management system 108 to activate based on the pre-defined or predetermined cooling demand for the battery pack 106 responsive to determining the battery pack 106 is in a charge mode and/or determining the heat load for the battery pack 106. For example, the BMS 102 may transmit a signal to the BTMS 104 to cause the thermal management system 108 to operate based on the accurately estimated heat load and/or the BTMS 104 may transmit a signal to the thermal management system 108 operate based on the known heat load. Responsive to receiving the pre-defined heat load or determining the pre-defined heat load, the BTMS 104 may modify or adjust the thermal management system 108 accordingly based on the determined heat load. In some implementations, since the charging rate and/or profile (e.g., voltage, current, etc.) may be pre-defined based on the charging state, the BTMS 104 may modify the cooling command of the thermal management system 108 in a pre-defined manner or in a pre-defined static map. Mapping the charging operation to a cooling demand via the BTMS 104 allows for a significantly simplified control logic and better cooling results from the thermal management system 108 as compared to conventional techniques.

Where the BMS 102 determines that the battery pack 106 is not in a charge mode, the BMS 102 may transmit one or more signals to the BTMS 104 indicating to continue operating the thermal management system 108 as-is. As another example, the BMS 102 may transmit a signal to the BTMS 104 indicating to not operate the thermal management system 108.

In some implementations, the method 500 may additionally or alternatively include pre-conditioning the battery pack 106 based on an upcoming or predicted charge event. For example, the BMS 102 and/or the BTMS 104 may be detect an upcoming charge event. The BMS 102 and/or the BTMS 104 may detect an upcoming charging event through various sensors or controllers throughout the system 100 indicating an initiation of a charge event. For example, the BMS 102 and/or the BTMS 104 may receive a signal from an offboard dispatching service of the system 100 indicating that a charging event will occur in within a predetermined period of time. The BMS 102 and/or the BTMS 104 may receive a signal from a sensor that a physical condition of the system 100 indicating that a charge event will occur within a predetermined period of time, such as a door of a charge port within the system 100 being opened, as another example. Responsive to detecting that a charge event will occur within a future time window, the BMS 102 and/or the BTMS 104 may cause the thermal management system 108 to start a flow of coolant and/or decrease a temperature of the coolant (e.g., between 15° C. to 18° C., or within another temperature range) to pre-cool the battery pack 106 in anticipation of the charge event. Such implementation minimizes a fluctuation in temperature of the battery pack 106 and/or reduces the maximum temperature of the battery pack 106 reached during a charge event to increase the lifetime and/or performance of the battery pack 106.

The method 500 of using pre-defined metrics of the battery pack 106 during a charging event to determine a heat load of the battery pack 106 allows the BMS 102 and the BTMS 104 to more efficiently cool the battery pack 106 as compared to conventional techniques where the thermal management system 108 is activated only responsive to a temperature reading of the battery pack 106 itself. Such implementation facilitates extending the overall lifetime of the battery pack 106 and/or increasing performance of the battery pack 106 by decreasing the time it takes for the thermal management system 108 to regulate a temperature of the battery pack 106 during a charge event of the battery pack 106. Moreover, the processing power and time of the system 100 is decreased as compared to conventional techniques because less power may be used to effectively cool the battery pack 106 during a charging event.

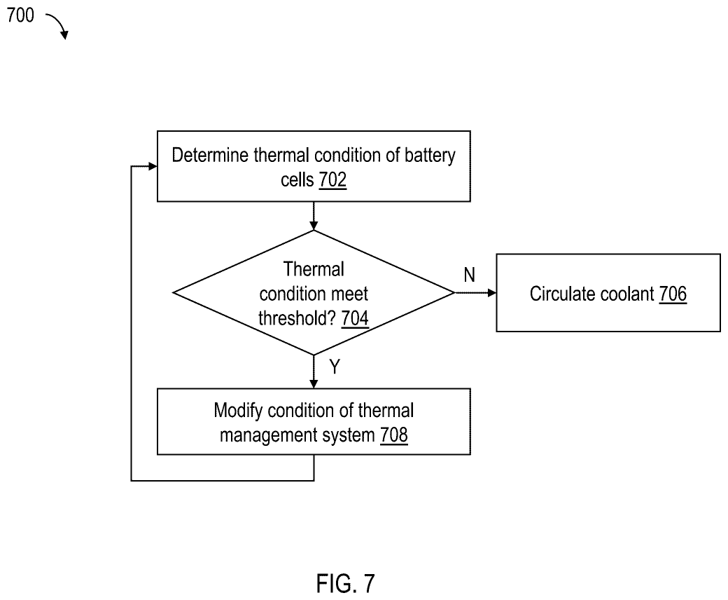

Referring now to FIG. 7, depicted is a flowchart showing an example method 700 of enhancing thermal management of the battery pack 106 based on a thermal condition of one or more battery cells 118 of the battery pack 106. The method 700 may be performed by, implemented on, or otherwise executed by the components, elements, or hardware described above with reference to FIG. 1. For example, the method 700 may be executed by the system 100 of FIG. 1. While steps of the method 700 may be described herein as being performed by one part of the system 100 (e.g., the BMS 102), the various steps of the method 700 may be performed by various additional or alternative components of the system 100 or vehicle (e.g., the BTMS 104 or another component).

At step 702, the BTMS 104 may determine a thermal condition of one or more battery cells 118 of the battery pack 106. For example, as described in greater detail with reference to FIG. 6, the thermal condition may include a maximum temperature of the battery cells 118, a minimum temperature of the battery cells 118, or an average temperature of the battery cells 118.

At act 704, the BTMS 104 may determine whether the thermal condition of the one or more battery cells 118 meets a threshold value. For example, as described in greater detail with reference to FIG. 6, the threshold value may include a cooling threshold (e.g., a temperature in which the thermal management system 108 activates cooling of the battery cells 118) or a heating threshold (e.g., a temperature in which the thermal management system 108 activates heating of the battery cells 118).

Where the BTMS 104 determines that the thermal condition does not meet a threshold value, the BTMS 104 may cause the thermal management system 108 to circulant a coolant through the thermal management system 108 at step 706. Where the BTMS 104 determines that the thermal condition does meet a threshold value, the BTMS 104 may cause the thermal management system 108 to modify a temperature of the thermal management system 108 at step 708. For example, as described in greater detail with reference to FIG. 6, where the BTMS 104 determines that a minimum temperature of the battery cells 118 or an average temperature of the battery cells 118 is less than the heating threshold, the BTMS 104 may cause the thermal management system 108 to increase the temperature of the coolant to heat the battery cells 118 at least until one battery cell 118 (or an average temperature) reaches a temperature above the heating threshold or until at least one battery cell 118 (or an average temperature) reaches a temperature above the cooling threshold. As another example, where the BTMS 104 determines that a maximum temperature of the battery cells 118 or an average temperature of the battery cells 118 is greater than the cooling threshold, the BTMS 104 may cause the thermal management system 108 to decrease the temperature of the coolant to cool the battery cells 118 at least until one battery cell 118 (or an average temperature) reaches a temperature below the heating threshold or until at least one battery cell 118 (or an average temperature) reaches a temperature below the cooling threshold. The method 700 may continue to determine a thermal condition of the one or more battery cells 118 at step 702 to repeat or restart the method 700.

The method 700 of using a temperature measurement of one or more battery cells 118 and/or of an average temperature of the battery cells 118 to determine whether a temperature of the coolant should be modified allows the BTMS 104 to more efficiently cool the battery pack 106 as compared to conventional techniques where the BTMS 104 determines whether a temperature of the coolant should be modified based on a temperature of the coolant itself (e.g., as opposed to the one or more battery cells 118). Such implementation also increases the rate at which heat is exchanged between the battery cell(s) 118 and the coolant based on the BTMS 104 determining a temperature of the coolant responsive to a temperature of one or more battery cells 118 reaching a threshold, as the rate of heat exchange is based on a product of a difference in temperature between the one or more battery cells 118 and the coolant.

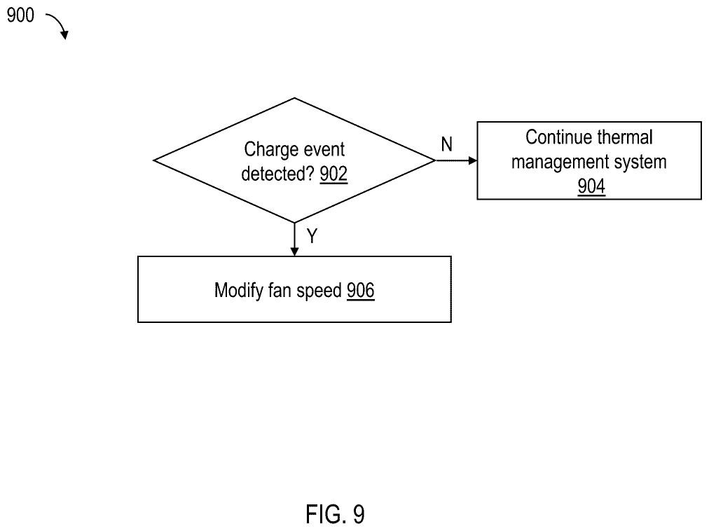

Referring now to FIG. 9, depicted is a flowchart showing an example method 900 of enhancing thermal management of a battery pack 106 by modifying a secondary thermal management system of a vehicle (e.g., the vehicle component thermal management system 124). The method 900 may be performed by, implemented on, or otherwise executed by the components, elements, or hardware described above with reference to FIG. 1. For example, the method 900 may be executed by the system 100 of FIG. 1. While steps of the method 900 may be described herein as being performed by one part of the system 100 (e.g., the BMS 102), the various steps of the method 900 may be performed by various additional or alternative components of the system 100 or vehicle (e.g., the BTMS 104 or another component).

At step 902, one or more components of the system 100 may determine whether a charge event of the battery pack 106 is detected. For example, the BMS 102, or another component of the system 100, may determine or detect a charge event for the battery pack 106 based on, for example, information (e.g., voltage, current, etc.) from a sensor of the battery pack 106, through communication with a charging device (e.g., via various protocols like a CAN bus and/or during a handshake process), and/or through a determination of a SOC increase based on voltage, current, and/or a time parameter of the battery pack 106. In some implementations, the BMS 102 and/or the BTMS 104 or another component of the system 100 may additionally or alternatively determine whether the system 100 is stationary based on various sensors or controllers of the system 100. In some implementations, the BMS 102 and/or the BTMS 104 may additionally or alternatively determine whether a battery pack 106 cooling demand exceeds a threshold. For example, the BMS 102 and/or the BTMS 104 or another control unit of the vehicle may determine, based on one or sensors 120 of the battery pack 106 and/or based on a predicted or pre-defined heat load determined according to the processes described herein, whether a cooling demand for the battery pack 106 meets a threshold value.

Where the BMS 102 and/or the BTMS 104 determines that there is no charge event detected and/or that a cooling demand of the battery pack 106 does not exceed a threshold, the BMS 102 and/or the BTMS 104 may cause the vehicle component thermal management system 124 to continue cooling the vehicle component communicably coupled to the vehicle component thermal management system 124 at step 904. For example, the BMS 102 and/or the BTMS 104 may transmit a signal to the vehicle component thermal management system 124 to continue cooling the vehicle component.

Where the BMS 102 and/or the BTMS 104 determines that there is a charge event detected and/or that a cooling demand of the battery pack 106 does exceed the threshold, the BMS 102 and/or the BTMS 104 may cause the vehicle component thermal management system 124 to modify a fan speed of the one or more fans 128 of the vehicle component thermal management system 124 at step 906. For example, the BMS 102 and/or the BTMS 104 may transmit a signal to the vehicle component thermal management system 124 to modify a fan speed of the fans 128. In some implementations, the vehicle component thermal management system 124 may modify a plurality of fans 128 at the same time. In some implementations, the vehicle component thermal management system 124 may modify one fan 128 of a plurality of the fans 128 or a subset of fans 128 of the plurality of fans 128. In some implementations, the vehicle component thermal management system 124 may modify one or more of the fans 128 by causing at least one of the fans 128 to stop (e.g., cause the fan speed of at least one fan 128 to be equal to 0 RPM), by causing at least one of the fans 128 to decrease in fan speed, and/or by causing at least one of the fans 128 to increase in fan speed.

The method 900 of selectively modifying a secondary vehicle component thermal management system 124 while the battery thermal management system 108 is running may facilitate increasing the efficiency of the thermal management system 108 by reducing recirculation of any potential warm air throughout the system 100. In other words, the BMS 102 and/or the BTMS 104 may cause the vehicle component thermal management system 124 to modify the fan speed of the fan(s) 128 to prioritize cooling of the battery pack 106 (e.g., when the battery pack 106 is undergoing a charging event or during another period of time) as compared to, for example, the vehicle component that the vehicle component thermal management system 124 is configured to cool. For example, modifying the fan speed of the fans 128 and/or turning off one or more fans 128 may facilitate reducing recirculation of any potential warm air throughout the system 100, which may interfere with or impact the effectiveness of the battery thermal management system 108. Therefore, selectively decreasing fan speed of the fans 128 of the secondary vehicle component thermal management system 124 may make the thermal management system 108 of the battery pack 106 more efficient.

What is claimed is:

1. A heavy vehicle, comprising:
a battery pack;
a first thermal management system, including a plurality of fans;
a second thermal management system, including a coolant circuit, arranged to cool the battery pack; and
one or more processors configured to:
detect a charge event of the battery pack; and
responsive to detecting the charge event, modify a fan speed of at least one of the plurality of fans of the first thermal management system to prioritize cooling of the battery pack via the second thermal management system.

2. The heavy vehicle of claim 1, wherein modifying the fan speed causes a reduction of airflow across the battery pack via the plurality of fans.

3. The heavy vehicle of claim 1, wherein the plurality of fans are arranged to provide airflow across at least one of a power inverter or converter of the heavy vehicle.

4. The heavy vehicle of claim 1, wherein modifying the fan speed comprises reducing the fan speed of a subset of the plurality of fans to greater than zero rotations per minute.

5. The heavy vehicle of claim 1, wherein modifying the fan speed comprises deactivating a subset of the plurality of fans.

6. The heavy vehicle of claim 1, wherein modifying the fan speed comprises reducing the fan speed of a first subset of the plurality of fans to greater than zero rotations per minute and deactivating a second subset of the plurality of fans.

7. The heavy vehicle of claim 1, wherein the plurality of fans comprise at least one power electronic fan.

8. A system, comprising:
a battery pack;
a first thermal management system, including a plurality of fans;
a second thermal management system, including a coolant circuit, arranged to cool the battery pack; and
one or more processors configured to:
detect a charge event of the battery pack; and
responsive to detecting the charge event, modify a fan speed of at least one of the plurality of fans of the first thermal management system to prioritize cooling of the battery pack via the second thermal management system.

9. The system of claim 8, wherein modifying the fan speed causes a reduction of airflow across the battery pack via the plurality of fans.

10. The system of claim 8, wherein the plurality of fans are arranged to provide airflow across at least one of a power inverter or converter of the system.

11. The system of claim 8, wherein modifying the fan speed comprises reducing the fan speed of a subset of the plurality of fans to greater than zero rotations per minute.

12. The system of claim 8, wherein modifying the fan speed comprises deactivating a subset of the plurality of fans.

13. The system of claim 8, wherein modifying the fan speed comprises reducing the fan speed of a first subset of the plurality of fans to greater than zero rotations per minute and deactivating a second subset of the plurality of fans.

14. The system of claim 8, wherein the plurality of fans comprise at least one power electronic fan.

15. A method of managing a thermal condition of a battery pack of a heavy vehicle, comprising:
detecting, by one or more processors, a charge event of the battery pack; and
responsive to detecting the charge event, modifying a fan speed of at least one fan of a plurality of fans of a first thermal management system to prioritize cooling of the battery pack via a second thermal management system.

16. The method of claim 15, wherein modifying the fan speed causes a reduction of airflow across the battery pack via the plurality of fans.

17. The method of claim 15, wherein the plurality of fans are arranged to provide airflow across at least one of a power inverter or converter of the heavy vehicle.

18. The method of claim 15, wherein modifying the fan speed comprises reducing the fan speed of a subset of the plurality of fans to greater than zero rotations per minute.

19. The method of claim 15, wherein modifying the fan speed comprises deactivating a subset of the plurality of fans.

20. The method of claim 15, wherein modifying the fan speed comprises reducing the fan speed of a first subset of the plurality of fans to greater than zero rotations per minute and deactivating a second subset of the plurality of fans.
